(19) United States
(12) Patent Application Publication
(10) Pub. No.: US 2016/0013966 A1
(43) Pub. Date: Jan. 14, 2016

(54) Device Circles

(71) Applicant: Microsoft Technology Licensing, LLC, Redmond, WA (US)

(72) Inventors: Shankar Vaidyanathan, Sammamish, WA (US); Todd L. Paul, Snohomish, WA (US); Yosseff Levanoni, Redmond, WA (US); Arvind Sethuraman, Bothell, WA (US); Weirong Zhu, Issaquah, WA (US); Lingli Zhang, Sammamish, WA (US)

(21) Appl. No.: 14/329,692

(22) Filed: Jul. 11, 2014

(51) Int. Cl. H04L 12/24; H04L 29/08

(52) U.S. Cl. CPC H04L 41/02; H04L 67/16

(57) ABSTRACT

Various embodiments enable a group of devices to be logically grouped together in what is referred to as a “device circle.” The devices in a device circle can be bound through static and dynamic bindings. In at least some embodiments, the device circle serves as a single abstract entity that does not necessarily expose its individual constituent devices. As such, communication and other functionality can take place with the device circle in a manner that does not divulge the identities, capabilities, or roles of the individual devices that make up the device circle.

### BACKGROUND

As technology continues to advance, the numbers and types of computing devices available in a wide variety of scenarios continues to increase rapidly. For example, the number of devices can run in the billions or even trillions. As the number of devices continues to increase, challenges are posed to provide efficient user experiences that leverage the wide variety of devices and the functionality associated with these devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments enable a group of devices to be logically grouped together in what is referred to as a “device circle.” The devices in a device circle can be bound through static and dynamic bindings. In at least some embodiments, the device circle serves as a single abstract entity that does not necessarily expose its individual constituent devices. As such, communication and other functionality can take place with the device circle in a manner that does not divulge the identities, capabilities, or roles of the individual devices that make up the device circle.

In at least some embodiments, membership in a device circle can be based on criteria drawn from semantic models that establish relationships based on properties or attributes of the devices.

The logical nature of device circles lends itself to flexible device circle structures such as overlapping device circles, multiple overlapping device circles, device circles within device circles, and various combinations thereof. These structures can be tailored in accordance with any suitable desired functionality to fit the needs of individuals and entities such as corporations, governmental agencies, and the like.

In at least some embodiments, device circles can be characterized as having states and behaviors. The state of a device circle can be defined by any suitable parameters. The behaviors of the device circle can be accessed through a suitable callable interface. In addition, individual device circles can be capable of certain actions and behaviors that their constituent devices individually may not be capable of.

In at least some embodiments, trust, security, and privacy issues are addressed through authorization models that define how device circles and devices in a particular device circle interact with one another, communicate, and consume information.

In at least some embodiments, a discovery and query model is employed to facilitate device circle discovery by other devices. In at least some embodiments, a device circle management service provides an application program interface (API) that can be called to discover relevant device circles and properties and characteristics of the device circles.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of an example device circle in accordance with one or more embodiments.

FIG. 3 is a flow diagram that describes steps in a method in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 illustrates an example circle structures in accordance with one or more embodiments.

FIG. 7 is a flow diagram that describes steps in a method in accordance with one or more embodiments.

FIG. 8 illustrates an example computing device that can be utilized to implement various embodiments described herein.

### DETAILED DESCRIPTION

Overview

Various embodiments enable a group of devices to be logically grouped together in what is referred to as a “device circle.” The devices in a device circle can be bound through static and dynamic bindings. In at least some embodiments, the device circle serves as a single abstract entity that does not necessarily expose its individual constituent devices. As such, communication and other functionality can take place with the device circle in a manner that does not divulge the identities, capabilities, or roles of the individual devices that make up the device circle.

In at least some embodiments, membership in a device circle can be based on criteria drawn from semantic models that establish relationships based on properties or attributes of the devices.

The logical nature of device circles lends itself to flexible device circle structures such as overlapping device circles, multiple overlapping device circles, device circles within device circles, and various combinations thereof. These structures can be tailored in accordance with any suitable desired functionality to fit the needs of individuals and entities such as corporations, governmental agencies, and the like.

In at least some embodiments, device circles can be characterized as having states and behaviors. The state of a device circle can be defined by any suitable parameters. The behaviors of the device circle can be accessed through a suitable callable interface. In addition, individual device circles can be capable of certain actions and behaviors that their constituent devices individually may not be capable of.

In at least some embodiments, trust, security, and privacy issues are addressed through authorization models that define how device circles and devices in a particular device circle interact with one another, communicate, and consume information.

In at least some embodiments, a discovery and query model is employed to facilitate device circle discovery by other devices. In at least some embodiments, a device circle management service provides an application program interface (API) that can be called to discover relevant device circles and properties and characteristics of the device circles.

In the following discussion, an example environment is first described that is operable to employ the techniques described herein. The techniques may be employed in the example environment, as well as in other environments.

### EXAMPLE ENVIRONMENT

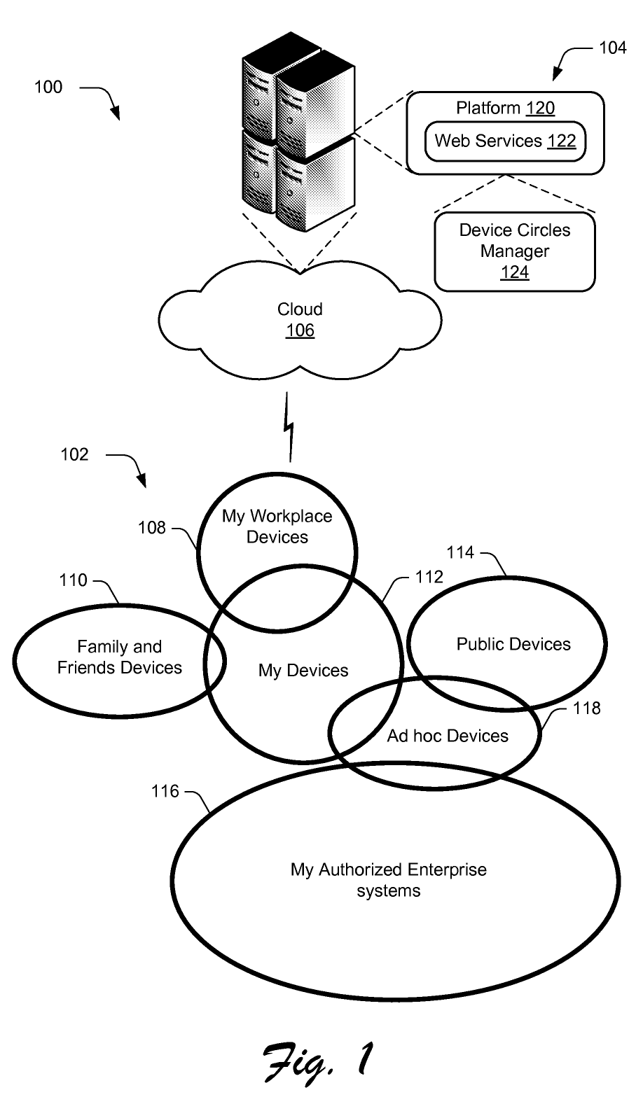

FIG. 1 illustrates an example environment 100 in an example implementation that is operable to employ the techniques described herein. The illustrated environment 100 includes one or more device circles 102, a device circle manager 104 and a network 106 through which the device circles and the device circle manager 104 can communicate.

In this particular example, the device circles 102 include various different types of device circles such as, by way of example and not limitation, a workplace device circle 108, a family and friends device circle 110, a “My devices” device circle 112, a public devices device circle 114, an authorized enterprise device circle 116, and an ad hoc devices device circle 118. Each of these different device circles is composed of a collection of devices. So, for example, the workplace device circle 108 can typically include devices that are found at a user's workplace. Likewise, the “my devices” device circle 112 includes a collection of devices that constitute him a user's own personal devices. Similarly, the authorized enterprise device circle 116 can include devices that have been authorized to interact with the user's “my devices” device circle 112.

In practice, a “device” can constitute any suitable type of device. For example, a device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles).

Further, devices can constitute those that are used in so-called “invisible computing” environments. Invisible computing environments typically refer to those environments that do not utilize much if any human interaction. Devices that are used in invisible computing environments can include, by way of example and not limitation, embedded control systems, consumer devices, intelligent sensors, smart home controls, communication-oriented devices and networking infrastructure, programmable peripherals and microcontrollers, home appliances, toys, games, and the like. In all these cases, the devices typically include inexpensive microprocessors, such as a DSP, a VLIW, or a micro-controller rather than a general-purpose computing capability or platform.

Cloud 106 is illustrated as including a device circle manager 104 in the form of a platform 120 for web services 122. Web services 122 includes a device circles manager 124 which performs various management functions as will be described below.

The platform 120 abstracts underlying functionality of hardware (e.g., servers) and software resources of the cloud 106 and thus may act as a “cloud operating system.” For example, the platform 120 may abstract resources to enable communication between device circles. The platform 120 may also serve to abstract scaling of resources to provide a corresponding level of scale to encountered demand for the web services 122, i.e., device circles that are implemented via the platform 120. A variety of other examples are also contemplated, such as load balancing of servers in a server farm, protection against malicious parties (e.g., spam, viruses, and other malware), and so on.

Thus, the cloud 106 is included as a part of the strategy that pertains to software and hardware resources that are made available to the device circles and devices within the device circles via the Internet or other networks.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

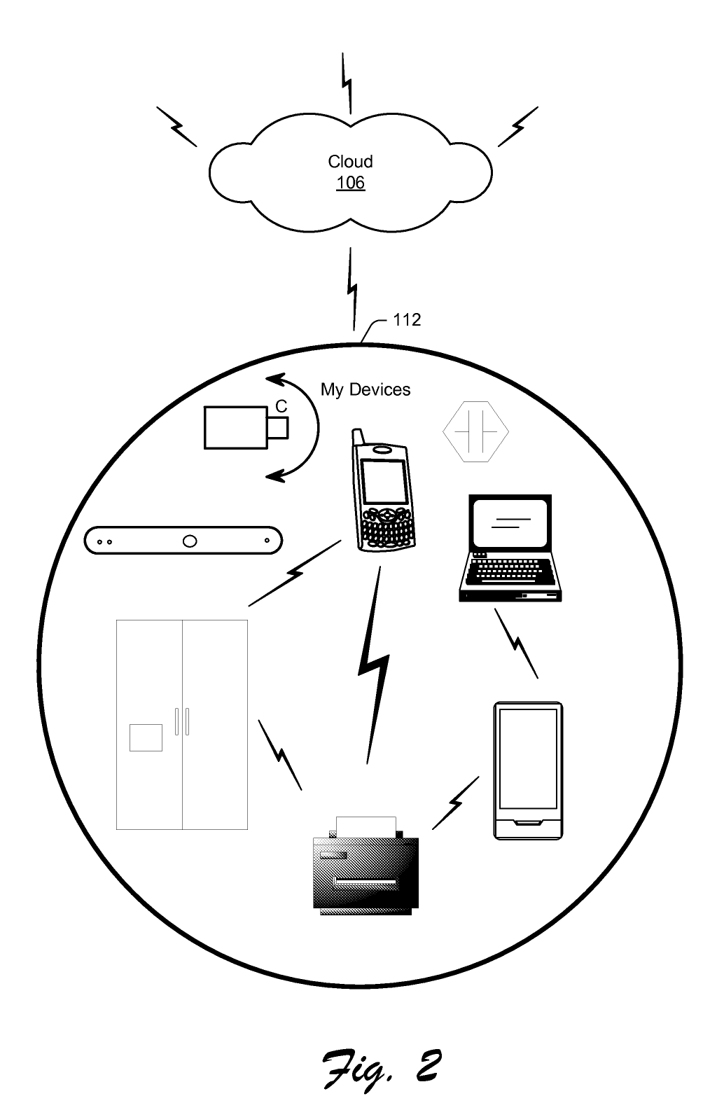

FIG. 2 illustrates one example of a device circle in the form of a “My devices” device circle 112. In this particular example, the device circle includes, (starting at or near the top of the device circle and proceeding clockwise), a camera, a smart phone, one or more sensors, a laptop computer, a tablet computer, a printer, a refrigerator, and a set-top box. Within the device circle, the individual devices can communicate with one another as indicated by the communication links. Communication with the individual devices is abstracted by the device circle as indicated by the communication link between device circle 112 and the cloud 106.

In the discussion that follows, a section entitled “Establishing Groupings of Devices through a Device Circle” describes the nature of device circles and how device circles can be formed. Next, a section entitled “Device Circle Membership” describes aspects of membership in a particular device circle in accordance with one or more embodiments. Following this, a section entitled “Interacting with a Device Circle As a Single Entity” describes abstraction aspects with which communication takes place between external entities and a device circle and its constituent devices. Next, a section entitled “Circles of Circles” describes structural aspects of device circles in accordance with one or more embodiments. Following this, a section entitled “Circles with State and Behavior” describes various characteristics and properties associated with device circles, in accordance with one or more embodiments. Next, a section entitled “Defining Behaviors at the Circle Level” describes how various behaviors can be defined with respect to a particular device circle. Following this, a section entitled “Device Circle Authorization Model” describes aspects of an authorization model that can be utilized with device circles in accordance with one or more embodiments. Next, a section entitled “Discoverability” describes how device circles can be discovered in accordance with one or more embodiments. Last, a section entitled “Example Device” describes aspects of an example device that can be utilized to implement one or more embodiments.

Establishing Groupings of Devices Through a Device Circle

Various embodiments enable a group of devices to be logically grouped together in what is referred to as a “device circle.” Device circles can enable logical groupings of various different types of devices, examples of which are provided above. Device circles define collective functionalities and behaviors, enable communication with other device circles and external entities, and perform various other functions described above and below.

Device circles can be formed in any suitable way. For example, in at least some embodiments a user can define a device circle as by, for example, including their user-owned devices in a particular circle. Alternately or additionally, an enterprise can define one or more particular device circles based upon various criteria.

In at least some embodiments, device circles are managed by a remote cloud-based service in the form of a device circles manager, an example of which is provided above. The device circles manager can maintain a scalable list of device circles, constituent member devices, properties and characteristics of the device circles and its constituent member devices, and the like. In at least some embodiments, the device circles manager utilizes a container membership implementation for the individual device circles. That is, each device circle is associated with a unique namespace. So, for example, the namespace approach can include an overarching primary namespace and, for each device circle, one or more sub-name spaces under the overarching primary namespace.

When a device is to be included in a particular device circle, the device circles manager can be notified and provided with information about the device such as device name, model number, properties and characteristics of the device, and the like. The device can then be added to the unique namespace for that device circle.

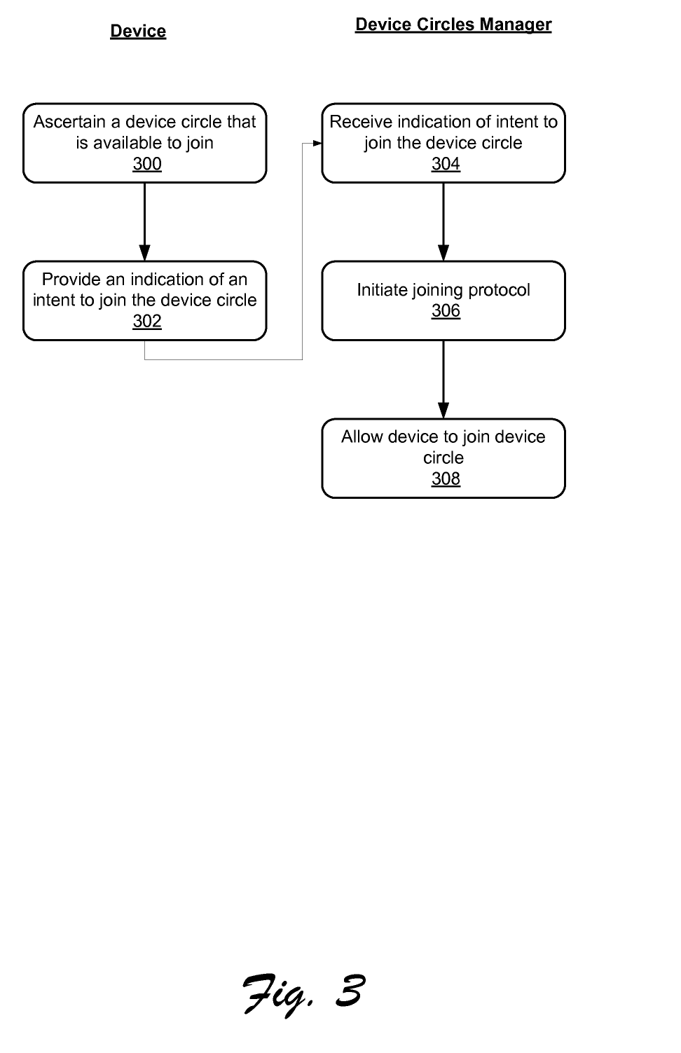

FIG. 3 is a flow diagram that describes steps in a method in accordance with one or more embodiments. The method can be performed using any suitable hardware, software, firmware, or combination thereof. In at least some embodiments, aspects of the method are performed by a device seeking to join a device circle, and other aspects are performed by a device circles manager. As such, the flow diagram has steps designated “Device” and “Device Circles Manager” to designate which entity performs which steps.

Step 300 ascertains a device circle that is available to join. This step can be performed in any suitable way. For example, in at least some embodiments the step can be performed by the device seeking to join the device circle. For example, a device may use a push or pull model to ascertain the availability of a device circle. For example, in a push model, a device circle may actively advertise its availability by sending notifications to devices in, for example, a certain location. In a pull model, a device seeking to join a device circle may actively seek out a particular device circle. Once a device circle is found, the device may present a user interface to enable the user to opt into joining the particular device circle. Alternately or additionally, this step can be performed by a device on behalf of the device that is to join the device circle. For example, assume, in a home scenario, the homeowner has several light sensors and other devices that she wishes to enter into a device circle. The homeowner may use her personal computer to access or otherwise ascertain her home device circle.

Step 302 provides an indication of an intent to join the device circle. The step can be performed in any suitable way. For example, this step can be performed by providing information to enable the device circles manager to enroll or otherwise join the device in a particular device circle. Any suitable information can be provided. For example, the information can include a unique identifier for the device, a device name, model number, device type, and the like. This step can also be performed either directly by a device seeking to join a particular device circle. Alternately or additionally, the step can be performed by a device on behalf of the device that is to join the device circle.

Step 304 receives the indication of the intent to join the device circle. Receipt of the indication can come by way of any suitable network such as the Internet, an intranet, and the like. Step 306 initiates a joining protocol for the device associated with the received content to join. Any suitable type of joining protocol can be utilized. For example, the joining protocol may include simply adding the device to a list of devices for that particular device circle. In at least some embodiments, this can include associating the device with the device circle's unique identifier, e.g., the unique namespace. In at least some other embodiments, the joining protocol can include authentication and verification processes to ensure that only authorized devices are permitted to join the device circle. As a result of the joining protocol at step 306, step 308 allows the device to join the device circle. This can include, for example, setting permissions for the device, establishing access settings that describe how the device is to interact with other devices of the device circle, and the like.

Having considered the notion of device circles, consider now aspects of device circle membership in accordance with one or more embodiments.

Device Circle Membership

The devices in a device circle can be bound through static and dynamic bindings which are based on criteria. The criteria can be drawn from semantic models that establish relationships based on properties and attributes. The criteria can change over time and, as it changes, so too can the constituent devices of a particular device circle. The criteria can be defined in any suitable way and, in at least some instances, can be expressed as a complex expression for membership. That is, a complex expression might include multiple criteria at least some of which being conditional and based upon some conditional aspect associated with the device. So, for example, membership in a particular device circle can be modified by not only a change in the criteria used to establish the bindings of the device circle, but by a state change associated with a particular individual device.

Static bindings can include logical groupings based on properties and attributes of devices that do not change. For example, static bindings can be based on device type, model number, owner, function, static location, and the like. Dynamic bindings can include logical groupings based on properties and attributes of devices that do typically change. For example, dynamic bindings can include location, current user, currently executing application, devices that have been approved, and the like. With dynamic bindings, conditional criteria can be utilized to define the membership of the device circle, e.g., “Did a device leave the current location such that it does not qualify for the device circle?”

As an example, consider a typical home scenario. Devices that reside within the home may be placed within a device circle. Similarly, devices that reside on each floor of the home may be placed in a respective device circle associated with each floor. Alternately or additionally, devices that belong to Dad and Mom may be placed in a parent device circle, while devices that belong to each child may be placed in corresponding children device circles.

In an enterprise scenario, device circles might be defined to include all of the light systems having sensors in the same building, all HVAC systems in all buildings on campus A, all printers on the fourth floor of Building 2, and so on.

In addition, default canonical groups can be defined and administered by the device circles manager to facilitate management of devices within device circles.

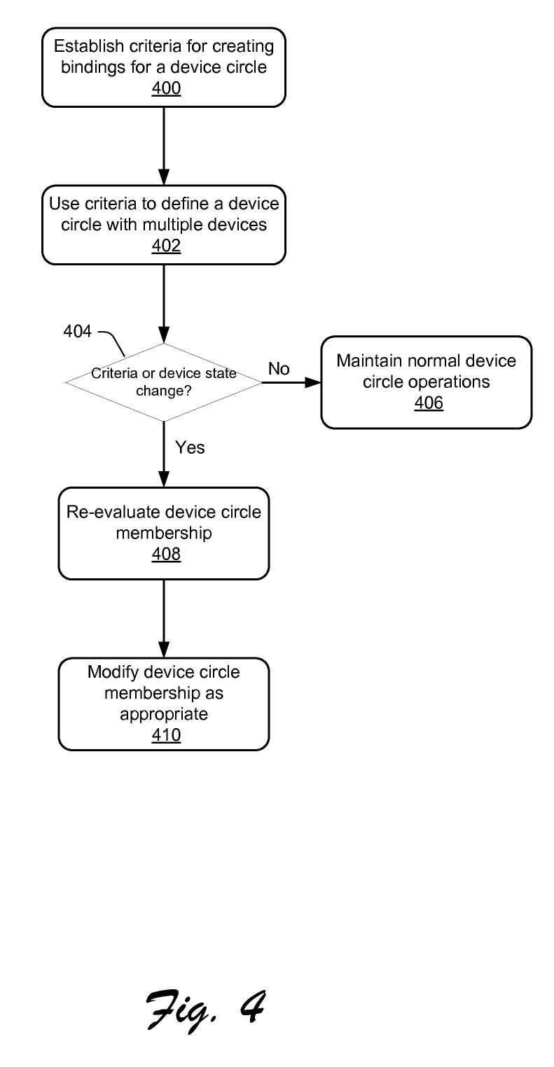

FIG. 4 is a flow diagram that describes steps in a method in accordance with one or more embodiments. The method can be performed using any suitable hardware, software, firmware, or combination thereof. In at least some embodiments, aspects of the method are performed by a device circles manager.

Step 400 establishes criteria for creating bindings for a device circle. Examples of criteria and device bindings are provided above. Step 402 uses the criteria to define a device circle with multiple devices. That is, this step uses the criteria to build a device circle that includes multiple devices. Step 404 ascertains whether the criteria or a device state has changed. If neither the criteria nor the device state has changed, step 406 maintains normal device circle operations. This can include the normal and typical management and administrative functions performed by the device circles manager. If, on the other hand, the criteria or a device state has changed, step 404 reevaluates the device circle membership. That is, the device circles manager can run the criteria against the member devices to ascertain whether any devices need to be removed from the device circle. In addition, running the criteria can also include running the criteria against devices that are not members of the device circle to ascertain whether the devices should be added to the device circle or offered membership into the device circle. For example, if the criteria is location-based criteria that permits devices to join a device circle based on proximity to a certain location, when new devices enter into the proximity, the criteria can then be run to ascertain whether the new device should be admitted to the device circle or offered membership in the device circle.

Having considered aspects of device circle membership, consider now notions associated with interacting with a device circle.

Interacting with a Device Circle as a Single Entity

In at least some embodiments, the device circle serves as a single abstract entity for communicating with devices of the device circle. The device circle may or may not choose to expose its individual constituent devices or subsets of its constituent devices. As such, it is possible for communication and other functionality to take place with the device circle in a manner that does not divulge the identities, capabilities, or roles of the individual devices that make up the device circle.

Thus, outside systems and entities can communicate with a device circle as a complete intelligence system, rather than with its individual constituent parts. In at least some instances, these outside systems and entities can communicate through the device circles manager using a device circle's unique namespace. The device circles manager can then use its knowledge of the device circle and its properties and characteristics to act upon the communication that it receives from the outside systems and entities. This can be particularly useful for enterprises and government establishments to enable participation in a device circle without divulging the identity, capability, and role of the individual devices of the device circle.

As an example, consider the following. Device circles, by virtue of their constituent devices, have a set of actions and capabilities that they can perform. These actions and capabilities stem from the functionality of the constituent devices of the device circle. An external system or entity can communicate with the device circle to invoke a set of actions. Based on the set of actions that are invoked, the behavior of the circle can change. That is to say, device circles can perform different functions based upon an action that is invoked. As an example, consider the following.

Assume that the local utility company wishes to communicate a scheduled power outage between 9 a.m. and 10 a.m. next Wednesday in order to upgrade their transmission cables. In order to communicate this power outage to one of its customers, the utility company communicates with the home device circle of its customer through the device circles manager. In this manner, each device, as appropriate, is notified of the power outage. This relieves the utility company from having to communicate the power outage to each individual device affected in the device circle. In fact, the utility company may not be aware of the devices in the customer's device circle. Using the device circle can greatly streamline the manner in which communication takes place.

On the subject of device circle interactions, communication can take place in a two- or multi-way fashion. Specifically, outside entities can invoke a connection and communicate with a device circle and a device circle can communicate with outside entities. For example, an outside entity such as a utility company may receive events and messages from a device circle. As an example, the utility company may contact a particular home device circle and request the total utility consumption for the previous month for use in its metrics calculation. The device circle can perform an action associated gathering the consumption information and return this information to the utility company. In addition, the device circle is capable of initiating communications with outside entities. As an example, consider that a particular home had a sudden overload or surge. The home's device circle can prepare message to the utility company indicating that an overload or surge situation has occurred. This communication can be directly to the utility company or, alternately, can occur through the device circles manager.

In addition, communication can occur responsive to an outside entity subscribing to certain “topics” associated with device circles. These topics can include any suitable subject matter. For example, in the utility company example above, one topic might be “power outages.” Thus, by subscribing to a power outage topic, the utility company would be automatically notified by any device circles that experienced or observed a power outage.

In addition, two-way communication can take place between device circles. For example, assume that a house has a device circle for devices on its first floor, and another device circle for devices in its basement. Assume also that the utility company charges based upon the peak power consumption. In this instance, it can be useful for the device circles to communicate with one another and identify times where devices can operate in a manner that reduces peak power utilization. In this instance, the circle-to-circle communication can be either direct communication or the communication can be conducted through a third-party such as the device circles manager.

Circle-to-circle communication can also facilitate discoverability. As an example, consider the following. The typical vehicle can have multiple different types of devices such as a phone, radio, devices monitoring operation of the engine, and the like. These devices can all be part of a device circle associated with the vehicle. Assume also that a public system has a series of devices distributed along highway routes. These devices can include, by way of example and not limitation, cameras, computing devices to perform traffic congestion analysis, and the like. These computing devices belong to a device circle associated with the public system. When the vehicle is in the proximity of or using a highway route, the vehicle's device circle and public system's device circle can learn of each other and subsequently communicate with each other. So, for example, the device circle of the public system may note that there is traffic congestion near Bellevue on I-405 North. The public system's device circle can communicate with the device circle of the vehicle to notify it of the traffic congestion and possibly suggest alternate routes. The vehicle's device circle can populate this information up to the driver so that the driver can then make an informed decision regarding an alternate route. Further, assume the driver is on her way to a meeting and, because of the congestion in alternate route, she is going to run late. The vehicle's device circle can communicate with the driver's workplace device circle so that a calendar adjustment can be made to the driver's calendar.

Discoverability can also be facilitated through the device circles manager. Specifically, the device circles manager can maintain an enumeration system that lists a collection of available device circles. This list can be provided to various device circles so that they can become aware of other available device circles. For example, the device circles manager may include a category called “public system device circles” which lists available public system device circles and how to access the device circles. This list can be published across various other device circles and used as appropriate.

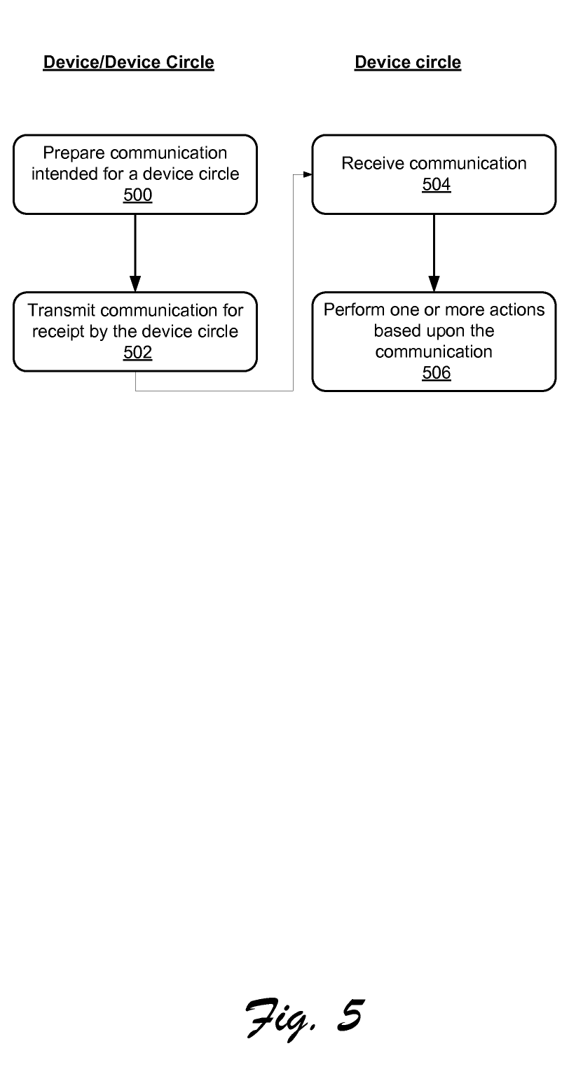

FIG. 5 is a flow diagram that describes steps in a method in accordance with one or more embodiments. The method can be performed using any suitable hardware, software, firmware, or combination thereof. In at least some embodiments, aspects of the method are performed by a device or a first device circle, and other aspects are performed by a second device circle.

Step 500 prepares a communication intended for a device circle. This step can be performed in any suitable way using any suitable type of communication. Communications can include messages, events, status updates, location-specific messages, and the like. In addition, this step can be performed by a device outside of the device circle for which the communication is intended. Alternately or additionally, this step can be performed by a device circle other than the device circle for which the communication is intended. Step 502 transmits the communication for receipt by the device circle. This step can be performed in any suitable way. For example, this step can be performed by transmitting the communication directly to the intended device circle. Alternately or additionally, this step can be performed by transmitting the communication to a third party such as a device circles manager, with the device circles manager then acting on the communication to send it to the intended device circle.

Step 504 receives the communication. This step is performed by the intended device circle. Step 506 then performs one or more actions based upon the communication. Any suitable type of actions can be performed, examples of which are provided above.

Having considered device circle interactions, consider now the notion of circles of circles and other circle structures.

Circles of Circles

The logical nature of device circles lends itself to flexible device circle structures such as overlapping device circles, multiple overlapping device circles, device circles within device circles, and various combinations thereof. These structures can be tailored in accordance with any suitable desired functionality to fit the needs of individuals and entities such as corporations, governmental agencies, and the like.

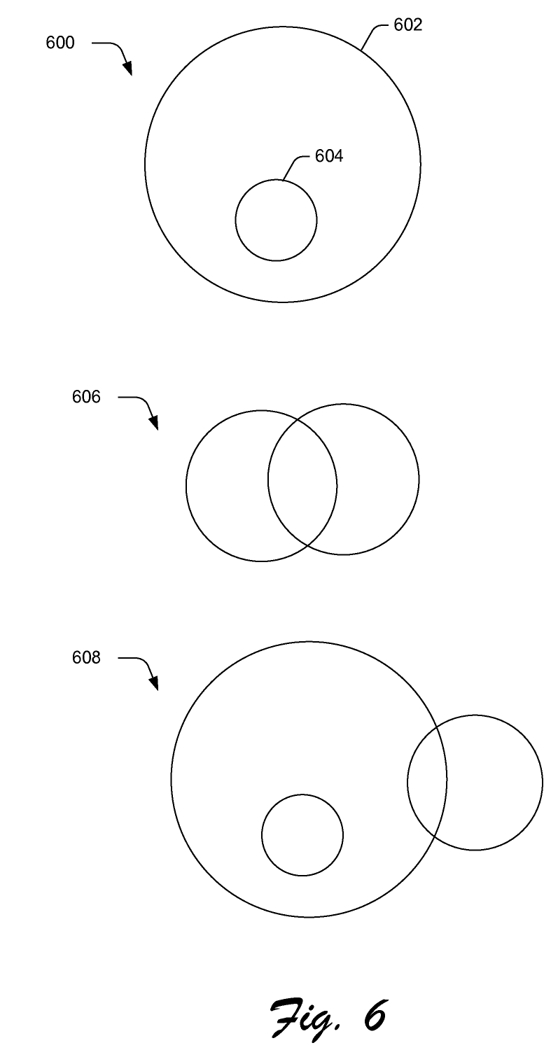

As an example, consider FIG. 6. There, a circle structure in the form of a device circle within a device circle is shown generally at 600. Circle structure 600 includes a first device circle 602 that includes a number of different devices, as well as a second device circle 604 within device circle 602. In this instance, device circle 602 may correspond to a neighborhood device circle, while device circle 604 may correspond to an individual home device circle within the neighborhood device circle. In this structure, any suitable action can be addressed to any device circle and it is up to that particular device circle to figure out how to propagate down the particular action. For example, assume that the utility company decides to shut power down because it is upgrading its fiber-optic cable. The utility company could communicate the power shut down to each individual home. Alternately, the utility company could communicate the power shut down to the neighborhood device circle which, in turn, can decide how to process that information relative to device circles contained therewithin.

Other device circle structures can include overlapping device circles such as the one shown at 606, device circles within device circles including an overlapping circle such as that shown at 608, and the like.

Accordingly, device circle structures provide added flexibility in terms of providing flexible architectures that can be driven by the functionality that is desired to be achieved.

Having considered device circle structures, consider now the notion of circles having state and behavior.

Circles with State and Behavior

As discussed above, device circles can be characterized as having states and behaviors. The state of a device circle can be defined by any suitable parameters. The behaviors of the device circle can be accessed through a suitable callable interface. In addition, individual device circles can be capable of certain actions and behaviors that their constituent devices individually may not be capable of.

In some embodiments, states can be considered as properties of a device circle that are readable and/or writable either by the constituent device or from some external entity, e.g., another device, another device circle, the device circles manager, and the like. Behaviors can be performed on or by a device circles. Device circles can expose these behaviors through a callable interface that can be called by external devices or systems. For example, it may be possible to shut down all devices in a particular device circle through a single command. It is to be appreciated and understood that the manner in which individual devices or device circles behave for a particular action is implementation dependent. For example, in the case of disparate devices belonging to the same circle, such as televisions and refrigerators in a home circle, a command such as “tune to channel” would not be applicable to the refrigerator.

As another example, consider a home security system that has its own device circle. The device circle includes door and window sensors and security cameras. Assume that the security system is on and that all the perimeters are locked. Thus, the device circle can be said to have a “locked” state. Now, a behavior can be invoked through a command to the device circle to “unlock the front door.” This behavior would unlock the front door and hence, change the state of the device circle to something other than “locked.”

Communication can also take place between a device or device circle and another device circle to query its state. So, for example, the homeowner sitting at work could use their smart phone to issue a query on their home security system's device circle to query its state. In this instance, the query could be transmitted to the device circles manager and then sent to the home security system's device circle. The device circle might respond that its state is “unlocked.” Upon learning this, the homeowner could issue a command to invoke the behavior of the device circle to change its state to “locked.”

Having considered device circles and associated states and behaviors, consider now an extension of that notion.

Defining Behaviors at the Circle Level

In at least some embodiments, device circles can be capable of certain actions and behaviors that their constituent devices individually may not be able to support. In this manner, behaviors can be defined at the circle level and may be implemented by drawing on functionality of individual devices that reside within the device circle. As an example, consider the following. A device circle may contain a smart phone and a scanner. The smart phone has its typical functionality, as does the scanner. The device circle, however, may expose “fax” functionality. Individually, the smart phone cannot fax a document, nor can the scanner. However, the device circle, through its runtime, can collectively perform fax functionality by having the scanner scan a document, articulate that document electronically to the smart phone which can then electronically send the document to an intended recipient. Similarly, a device circle may contain a printer and scanner and expose “copier” functionality. In this instance, the scanner would perform its normal function of scanning a document which would then be articulated to the printer. The printer could then perform its normal function and print the document thus providing “copier” functionality.

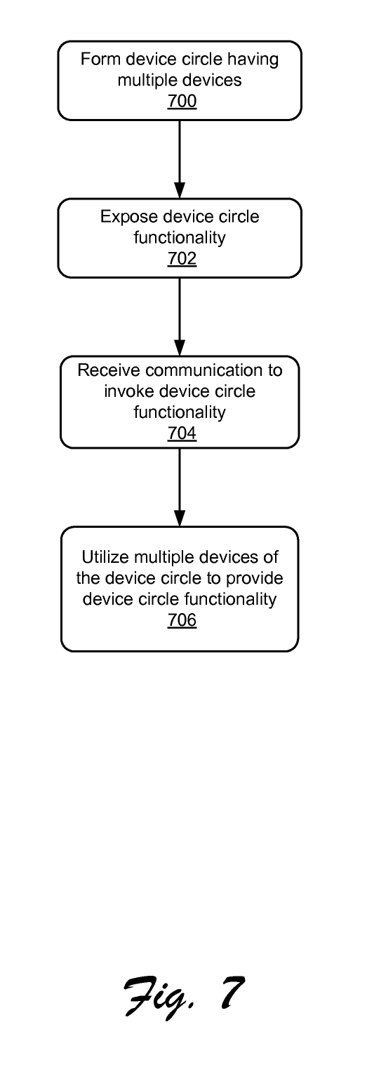

FIG. 7 is a flow diagram that describes steps in a method in accordance with one or more embodiments. The method can be performed using any suitable hardware, software, firmware, or combination thereof. In at least some embodiments, aspects of the method are performed by a device circle and two or more of its constituent devices.

Step 700 forms a device circle having multiple devices. In the illustrated and described embodiment, each of the multiple devices can support different types of functionality. For example, the first of the devices may support a first particular type of functionality and a second of the devices may support a second different particular type of functionality. Step 702 exposes device circle functionality. This step can be performed in any suitable way. For example, device circle functionality can be exposed through a suitably-configured API. In at least some embodiments, some of the device circle functionality includes functionality that is not individually supported by the device circle's constituent devices. Yet, constituent devices can collectively combine their individual functionality to provide the device circle functionality that is exposed. Two examples of how this can be done are provided above. Step 704 receives a communication to invoke the device circle functionality. This communication can be received in any suitable way such as, for example, the API mentioned just above. Step 706 utilizes multiple devices of the device circle to provide the device circle functionality. This can include, for example, using two or more devices to provide the functionality. In operation, a first of the devices can perform a subset of activities to provide a portion of the device circle functionality, and a second and/or additional devices can perform subsets of activities, respectively, to provide additional portions of the device circle functionality. In this instance, no one device is capable of providing the device circle functionality. Yet, collectively, when the individual device functionalities are combined in an intelligent manner, the device circle functionality can be provided.

Overseeing this synergistic aspect of device circles can be performed by any suitable entity and in any suitable manner. For example, a device circle controller (such as one in the device circle's runtime environment) can be utilized and can be knowledgeable of the individual functionality of the constituent devices. The device circle controller can then direct the actions of its devices to achieve this functional synergy. Oversight can also be achieved through other approaches such as, by way of example and not limitation, a master/slave structure, a peer-to-peer structure, a device circles manager and the like.

Having considered defining behaviors at the circle level, consider now a device circle authorization model in accordance with one or more embodiments.

Device Circle Authorization Model

In at least some embodiments, trust, security, and privacy issues are addressed through authorization models that define how device circles and devices in a particular device circle interact with one another, communicate, and consume information.

With respect to security and trust, each device circle can utilize an authorization model that defines how the devices in the device circle interact, communicate, and utilize each other's data and information. That is, the privileges and the actions on data or information can clearly be defined for a device circle. As an example, an individual may have a device circle that includes their cell phone, car, refrigerator, and thermostat. Because this device circle is a private device circle and trusted by the individual, a lower level of authorization can be utilized to enable the devices to freely exchange information and data. So, in this example, the refrigerator is free to share its inventory information with the cell phone so that the individual can pick up needed items when they are out abroad. At the same time, it would be undesirable for individual devices in this particular device circle to share information with other outside devices. In this case, a higher level of authorization can be utilized to ensure that information of the device circle is protected and not inadvertently or impermissibly shared. So, for example, a vehicle device circle may have a very high authorization level when it comes to communicating with a highway sensor system device circle. In this instance, the vehicle's device circle may not be able to do more than query the highway sensor system device circle and perhaps expose only a restricted set of actions or behaviors.

Having considered authorization models in accordance with one or more embodiments, consider now the notion of discoverability.

Discoverability

In at least some embodiments, a discovery and query model is employed to facilitate device circle discovery by other devices. In at least some embodiments, a device circle management service provides an application program interface (API) that can be called to discover relevant device circles and properties and characteristics of the device circles. Thus, authorized entities can use the API to learn about device circles and particular devices within device circles as appropriate. It is to be appreciated, however, that memberships in device circles can change. As such, memberships in at least some instances are true only for those canonical points of time when queries are made.

Having considered discoverability issues, consider now an example device that can be included within a device circle.

Example Device

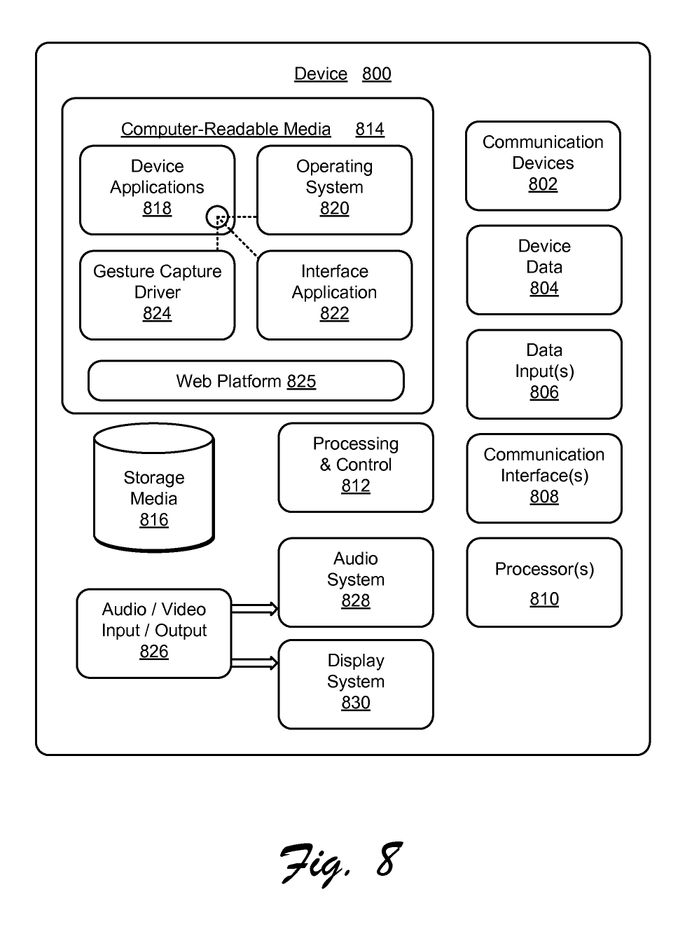

FIG. 8 illustrates various components of an example device 800 that can be implemented as any type of computing device that can be included in a device circle. As noted above, device circles can include many different types of varied devices. As such, device 800 constitutes but one example of a device that can be included in a device circle.

Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as user-selectable inputs, messages, music, television media content, recorded video content, and any other type of audio, video, and/or image data received from any content and/or data source.

Device 800 also includes communication interfaces 808 that can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like) which process various computer-executable instructions to control the operation of device 800 and to implement embodiments of the techniques described herein. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include a mass storage media device 816.

Computer-readable media 814 provides data storage mechanisms to store the device data 804, as well as various device applications 818 and any other types of information and/or data related to operational aspects of device 800. For example, an operating system 820 can be maintained as a computer application with the computer-readable media 814 and executed on processors 810. The device applications 818 can include a device manager (e.g., a control application, software application, signal processing and control module, code that is native to a particular device, a hardware abstraction layer for a particular device, etc.). The device applications 818 also include any system components or modules to implement embodiments of the techniques described herein. In this example, the device applications 818 include an interface application 822 and a gesture capture driver 824 that are shown as software modules and/or computer applications. The gesture capture driver 824 is representative of software that is used to provide an interface with a device configured to capture a gesture, such as a touchscreen, track pad, camera, and so on. Alternatively or in addition, the interface application 822 and the gesture capture driver 824 can be implemented as hardware, software, firmware, or any combination thereof. Additionally, computer readable media 814 can include a web platform 825 that provides browser functionality.

Device 800 also includes an audio and/or video input-output system 826 that provides audio data to an audio system 828 and/or provides video data to a display system 830. The audio system 828 and/or the display system 830 can include any devices that process, display, and/or otherwise render audio, video, and image data. Video signals and audio signals can be communicated from device 800 to an audio device and/or to a display device via an RF (radio frequency) link, S-video link, composite video link, component video link, DVI (digital video interface), analog audio connection, or other similar communication link. In an embodiment, the audio system 828 and/or the display system 830 are implemented as external components to device 800. Alternatively, the audio system 828 and/or the display system 830 are implemented as integrated components of example device 800.

### CONCLUSION

Various embodiments enable a group of devices to be logically grouped together in what is referred to as a “device circle.” The devices in a device circle can be bound through static and dynamic bindings. In at least some embodiments, the device circle serves as a single abstract entity that does not necessarily expose its individual constituent devices. As such, communication and other functionality can take place with the device circle in a manner that does not divulge the identities, capabilities, or roles of the individual devices that make up the device circle.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
ascertaining a device circle that is available to join, the device circle comprising a plurality of devices and representing an abstraction that logically groups the plurality of devices together;
providing an indication of an intent to join the device circle; and
joining the device circle.

2. The computer-implemented method of claim 1, wherein said providing comprises providing the indication to a remote device circles manager.

3. The computer-implemented method of claim 1, wherein at least some device circle communication with outside entities takes place through a remote device circles manager.

4. The computer-implemented method of claim 1, wherein the device circle is configured to use static and dynamic bindings to bind devices in the device circle.

5. The computer-implemented method of claim 1, wherein the device circle is configured to not expose its individual constituent devices.

6. The computer-implemented method of claim 1, wherein the device circle is configured to communicate with an outside entity to invoke a set of device circle actions.

7. One or more computer readable storage media storing computer-readable instructions which, when executed, perform operations comprising:
receiving, from a device, an indication of an intent to join a device circle, the device circle comprising a plurality of devices and representing an abstraction that logically groups the plurality of devices together;
initiating a joining protocol for the device; and
allowing the device to join the device circle.

8. The one or more computer readable storage media of claim 7, wherein said initiating a joining protocol comprises associating the device with a unique identifier of the device circle.

9. The one or more computer readable storage media of claim 7, wherein said allowing comprises at least one of:
setting permissions for the device; or
establishing access settings that describe how the device is to interact with other devices of the device circle.

10. The one or more computer readable storage media of claim 7, wherein membership in the device circle can be modified by one or more of:
a change in criteria used to establish device bindings in the device circle; or
a state change associated with a particular individual device.

11. The one or more computer readable storage media of claim 7, wherein said receiving, initiating, and allowing are performed by a remote device circles manager, and further wherein at least some communication from outside entities to the device circle takes place through the remote device circles manager.

12. A computing device comprising:
one or more processors;
one or more computer readable storage media storing instructions which, when executed by the one or more processors, perform operations comprising:
establishing criteria for creating bindings for a device circle, the device circle comprising a plurality of devices and representing an abstraction that logically grouped the plurality of devices together;
using the criteria to define a device circle with multiple devices;
ascertaining whether the criteria or a device state has changed;
maintaining normal device circle operations when neither the criteria nor the device state has changed; and
reevaluating device circle membership when either or both the criteria or the device state has changed.

13. The computing device of claim 12 further comprising, responsive to said reevaluating, adding one or more devices to the device circle.

14. The computing device of claim 12 further comprising, responsive to said reevaluating, removing one or more devices from the device circle.

15. The computing device of claim 12, wherein the device circle is configured to communicate with other device circles.

16. The computing device of claim 12 further comprising maintaining an enumeration that lists a collection of available device circles that can be discovered by individual devices.

17. One or more computer readable storage media storing instructions which, when executed, implement a system comprising:
one or more device circles, individual device circles comprising a plurality of devices and representing an abstraction that logically groups the plurality of devices together, the one or more device circles being configured to:
communicate with outside entities through a remote device circles manager;
use static and dynamic bindings to bind devices within a particular device circle;
modify membership of the device circle by adding or removing individual devices;
communicate with other device circles; and
be part of circle structures that include a device circle within a different device circle.

18. The one or more computer readable storage media of claim 17, wherein the one or more device circles have state and behaviors.

19. The one or more computer readable storage media of claim 17, wherein the one or more device circles have state that is readable and writable.

20. The one or more computer readable storage media of claim 17, wherein the one or more device circles have behaviors that are exposable through a callable interface.

21. The one or more computer readable storage media of claim 17, wherein at least some device circles are capable of behaviors that their constituent devices individually do not support.

22. The one or more computer readable storage media of claim 17, wherein at least some device circles utilize authorization models that define how devices in a particular device circle interact with one another.
